(19) United States
(12) Patent Application Publication
(10) Pub. No.: US 2024/0354636 A1
(43) Pub. Date: Oct. 24, 2024

(54) Domain Intelligence Engine for Automation

(71) Applicant: Bank of America Corporation, Charlotte, NC (US)

(72) Inventors: Sanjay Pillay, Round Rock, TX (US); Piedad L. Burnside, Hicksville, NY (US); Anton Sumin, Brooklyn, NY (US); Tushar Kapileshwar, Princeton, NJ (US); Balaji J. Maniwakkam, Frisco, TX (US)

(73) Assignee: Bank of America Corporation, Charlotte, NC (US)

(21) Appl. No.: 18/138,175

(22) Filed: Apr. 24, 2023

(51) Int. Cl. G06N 20/00

(52) U.S. Cl. CPC G06N 20/00

(57) ABSTRACT

Arrangements for intelligently orchestrating and automating requests are provided. In some aspects, configuration parameters and historical response data indicating a plurality of previous responses to requests may be received. Based on the configuration parameters and the historical response data, intelligence information associated with the requests may be extracted using a machine learning algorithm. An intelligence model may be built using the extracted intelligence information. A subsequent request may be received. One or more actions in response to the subsequent request may be automatically derived using the intelligence model. The subsequent request may be processed by executing the one or more actions. An accuracy of the intelligence model may be determined based on the configuration parameters. Responsive to the accuracy of the intelligence model being below a threshold, a self-learning algorithm based on the processed subsequent requests may be executed to improve the accuracy of the intelligence model.

### BACKGROUND

Aspects of the disclosure generally relate to computer hardware and software. In particular, one or more aspects of the disclosure generally relate to computer hardware and software for intelligently orchestrating and automating requests.

As an organization's infrastructure expands, the number of requests also increases, requiring additional resources to scale and respond to the growing demand. Requests may be captured and translated into an information technology (IT) service management system, and a record may be created. Typically, these requests are then manually reviewed and acted on by an analyst to provide the necessary service. In some instances, rules may be captured in a complex hierarchical nested structure and presented to users to select options based on the rules. One or more disadvantages of traditional approaches is that those rules are hard coded and require extensive maintenance and rework as new rules are identified. Moreover, the analyst must drill down through the rules manually to select an appropriate action. In many instances, it may be difficult to provide resolutions quickly and efficiently to service the requests.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with intelligently orchestrating and automating requests. In accordance with one or more embodiments, a computing platform having at least one processor, a communication interface, and memory may receive, via the communication interface, from a computing device, configuration parameters. The computing platform may receive, from a source data store, historical response data indicating a plurality of previous responses to requests. Based on the configuration parameters and the historical response data, the computing platform may extract, using a machine learning algorithm, intelligence information associated with the requests. The computing platform may build an intelligence model using the extracted intelligence information. The computing platform may receive, via the communication interface, from the computing device, a subsequent request. The computing platform may automatically derive, using the intelligence model, one or more actions in response to the subsequent request. The computing platform may process the subsequent request by executing the one or more actions in response to the subsequent request. The computing platform may determine an accuracy of the intelligence model based on the configuration parameters. Responsive to the accuracy of the intelligence model being below a threshold, the computing platform may execute a self-learning algorithm, based on the processed subsequent requests, to improve the accuracy of the intelligence model.

In some aspects, extracting the intelligence information associated with the requests may include determining intent of the requests.

In some example arrangements, receiving the configuration parameters may include receiving bias application information, word inclusion and exclusion criteria, and a threshold calibration setting.

In some embodiments, receiving the configuration parameters may include receiving different configurations for different lines of business.

In some arrangements, the computing platform may store, in the source data store, the one or more actions executed in response to the subsequent request.

In some aspects, processing the subsequent request may include executing an automation process.

In some example arrangements, processing the subsequent request may include providing assistance to an administrative computing device.

In some arrangements, extracting the intelligence information associated with the requests may include vectorizing words in the requests and assigning weights to the words.

In some examples, the computing platform may prompt a user of the computing device to set the configuration parameters.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for intelligently orchestrating and automating requests in accordance with one or more arrangements discussed herein;

FIGS. 2A-2E depict an illustrative event sequence for intelligently orchestrating and automating requests in accordance with one or more arrangements discussed herein;

FIG. 3 depicts an illustrative flow chart for intelligently orchestrating and automating requests in accordance with one or more arrangements discussed herein;

FIG. 4 depicts an example graphical user interface for intelligently orchestrating and automating requests in accordance with one or more arrangements discussed herein; and

FIG. 5 depicts an illustrative method for intelligently orchestrating and automating requests in accordance with one or more arrangements discussed herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure relate to building a configuration-driven mechanism that extracts domain specific intelligence and uses that intelligence to orchestrate and automate requests. In particular, one or more aspects of the disclosure may avoid the shortcomings of static, hardcoded manually configured rules. Additional aspects of the disclosure may provide a configuration-based framework that leverages self-learning and artificial intelligence to understand domain specific language and interpret the intent of a request. Additional aspects of the disclosure may partially or fully automate the orchestration of requests based on the configurable parameters.

These and various other arrangements will be discussed more fully below.

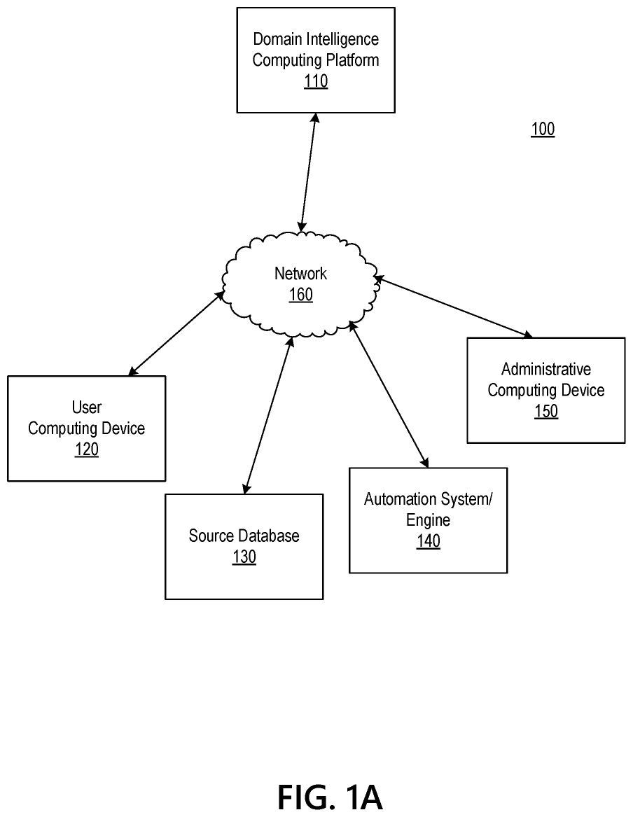

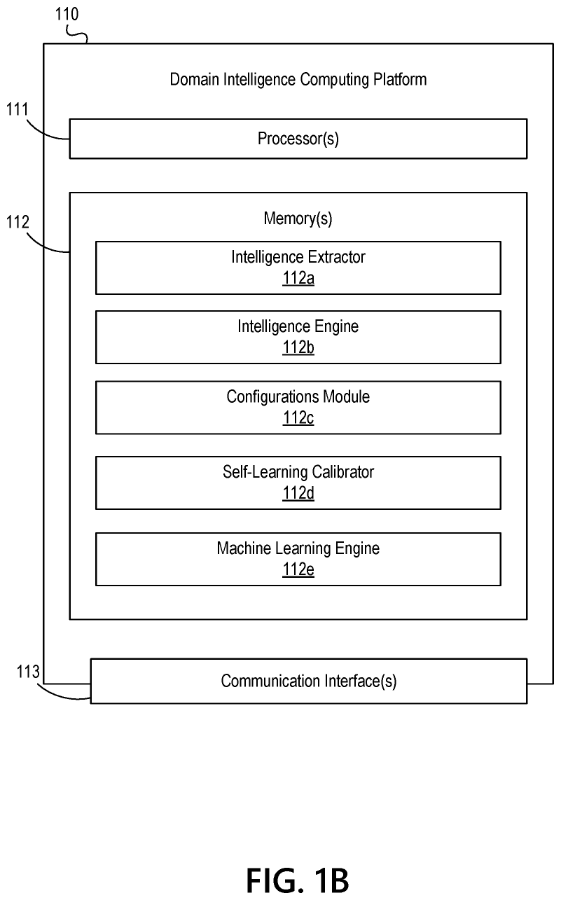

Aspects described herein may be implemented using one or more computing devices operating in a computing environment. For instance, FIGS. 1A and 1B depict an illustrative computing environment for intelligently orchestrating and automating requests in accordance with one or more example arrangements. Referring to FIG. 1A, computing environment 100 may include one or more computing devices and/or other computing systems. For example, computing environment 100 may include domain intelligence computing platform 110, user computing device 120, source database 130, automation system/engine 140, and/or administrative computing device 150. Although one user computing device 120 and one administrative computing device 150 are shown, any number of devices may be used without departing from the disclosure.

As described further below, domain intelligence computing platform 110 may include one or more computing devices configured to perform one or more of the functions described herein. For example, domain intelligence computing platform 110 may include one or more computers (e.g., laptop computers, desktop computers, servers, server blades, or the like) configured to perform intelligent orchestration and automation of requests and/or one or more other functions described herein. Among other functions, domain intelligence computing platform 110 may provide a configuration-based framework that leverages self-learning techniques to understand domain specific language and interpret the intent of a request which, based on configurable parameters, may partially or fully automate the orchestration of requests.

User computing device 120 may include one or more computing devices and/or other computer components (e.g., processors, memories, communication interfaces). For example, user computing device 120 may be a desktop computing device (e.g., desktop computer, terminal), or the like or a mobile computing device (e.g., smartphone, tablet, smart watch, laptop computer, or the like) used by users interacting with domain intelligence computing platform 110.

Source database/library 130 may include one or more computing devices and/or other computer components (e.g., processors, memories, communication interfaces) that may store a collection of historical requests based on past actions (e.g., past actions taken by a technician to service the requests). Source database 130 may include distinct and physically separate data centers or other groupings of server computers that are operated by and/or otherwise associated with an organization, such as a financial institution. In some examples, source database 130 may store information used by intelligence extractor 112a and/or domain intelligence computing platform 110 in performing intelligent orchestration and automation of requests and/or in performing other functions, as discussed in greater detail below. In some instances, different sets of historical requests for different lines of business may be stored in source database 130.

Automation system/engine 140 may include one or more computing devices or systems (e.g., servers, server blades, or the like) including one or more computer components (e.g., processors, memory, or the like) configured to perform automation of requests (e.g., service requests). In some examples, automation system/engine 140 may be and/or include robotic process automation (RPA) technology.

Administrative computing device 150 may include one or more computing devices and/or other computer components (e.g., processors, memories, communication interfaces). For instance, administrative computing device 150 may be a server, desktop computer, laptop computer, tablet, mobile device, or the like, and may be used by an information security officer, administrative user, or the like. In addition, administrative computing device 150 may be associated with an enterprise organization operating domain intelligence computing platform 110. In some examples, administrative computing device 150 may be used to configure, control, and/or otherwise interact with domain intelligence computing platform 110, and/or one or more other devices and/or systems included in computing environment 100.

Computing environment 100 also may include one or more networks, which may interconnect one or more of domain intelligence computing platform 110, user computing device 120, source database 130, automation system/engine 140, and administrative computing device 150. For example, computing environment 100 may include a network 160 (which may, e.g., interconnect domain intelligence computing platform 110, user computing device 120, source database 130, automation system/engine 140, administrative computing device 150, and/or one or more other systems which may be associated with an enterprise organization, such as a financial institution, with one or more other systems, public networks, sub-networks, and/or the like).

In one or more arrangements, domain intelligence computing platform 110, user computing device 120, source database 130, automation system/engine 140, and administrative computing device 150 may be any type of computing device capable of receiving a user interface, receiving input via the user interface, and communicating the received input to one or more other computing devices. For example, domain intelligence computing platform 110, user computing device 120, source database 130, automation system/engine 140, administrative computing device 150, and/or the other systems included in computing environment 100 may, in some instances, include one or more processors, memories, communication interfaces, storage devices, and/or other components. As noted above, and as illustrated in greater detail below, any and/or all of the computing devices included in computing environment 100 may, in some instances, be special-purpose computing devices configured to perform specific functions as described herein.

Referring to FIG. 1B, domain intelligence computing platform 110 may include one or more processors 111, memory 112, and communication interface 113. A data bus may interconnect processor(s) 111, memory 112, and communication interface 113. Communication interface 113 may be a network interface configured to support communication between domain intelligence computing platform 110 and one or more networks (e.g., network 160, or the like). Memory 112 may include one or more program modules having instructions that when executed by processor(s) 111 cause domain intelligence computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of domain intelligence computing platform 110 and/or by different computing devices that may form and/or otherwise make up domain intelligence computing platform 110.

For example, memory 112 may have, store and/or include an intelligence extractor 112a, an intelligence engine 112b, a configurations module 112c, a self-learning calibrator 112d, and a machine learning engine 112e. Intelligence extractor 112a may have instructions that direct and/or cause domain intelligence computing platform 110 to, for instance, use records from the source database 130 to extract intelligence information (e.g., understand the intent of a request and store that intelligence in machine-readable form which can be reused), and/or instructions that direct domain intelligence computing platform 110 to perform other functions, as discussed in greater detail below. In some examples, intelligence extractor 112a may have instructions that direct and/or cause domain intelligence computing platform 110 to use an appropriate artificial intelligence/machine learning (AI/ML) algorithm to vectorize the text entered by an end user in the request and provide meaningful weights. In some examples, intelligence extractor 112a may use the configurations module 112c to enrich the extraction process so the intelligence gathered can target the language used for a particular line of business.

Intelligence engine 112b may be built using the output of intelligence extractor 112a. Intelligence engine 112b may have instructions that direct and/or cause domain intelligence computing platform 110 to, for instance, use parameters from the configurations module 112c to make decisions on which actions should be completely automated versus providing appropriate aid to a technician. In some examples, intelligence engine 112b may invoke the self-learning calibrator 112d. Intelligence engine 112b may have instructions that direct and/or cause domain intelligence computing platform 110 to, for instance, read configuration parameters from the configurations module 112c to decide the condition and timing of when to launch self-learning calibrator 112d, and gather the latest intelligence parameters for future use. Intelligence engine 112b may accept new requests and infer the actions that need to be executed on the request, and/or perform other functions, as discussed in greater detail below.

Configurations module 112c may have instructions that direct and/or cause domain intelligence computing platform 110 to set configuration parameters including weight/bias application (e.g., positive/negative bias), word inclusion/exclusion (e.g., adding/removing words), accuracy threshold, or the like, and/or perform other functions, as discussed in greater detail below. In some examples, the configuration parameters may be included in an Extensible Markup Language (XML) file, a JavaScript Object Notation (JSON) file, or the like.

Self-learning calibrator 112d may have instructions that direct and/or cause domain intelligence computing platform 110 to evaluate actions that have been taken and the model accuracy, and recalibrate and apply new model parameters, and/or perform other functions, as discussed in greater detail below. Self-learning calibrator 112d may act as a feedback loop with increasing accuracy. Self-learning calibrator 112d may initiate calibration when a decrease in accuracy of the model is detected.

Machine learning engine 112e may use AI/ML algorithms to extract intelligence information associated with the requests. Machine learning engine 112e may have instructions that direct and/or cause domain intelligence computing platform 110 to set, define, and/or iteratively redefine rules, techniques and/or other parameters used by domain intelligence computing platform 110 and/or other systems in computing environment 100 in taking configurations input from a user and extracting intelligence information for intelligently orchestrating and automating requests. In some examples, domain intelligence computing platform 110 may build and/or train one or more machine learning models. For example, memory 112 may have, store, and/or include historical/training data. In some examples, domain intelligence computing platform 110 may receive historical and/or training data and use that data to train one or more machine learning models stored in machine learning engine 112e. The historical and/or training data may include, for instance, historical request data, and/or the like. The data may be gathered and used to build and train one or more machine learning models executed by machine learning engine 112e to derive or infer one or more actions to be executed on a request, taking into account given configurations, and/or perform other functions, as discussed in greater detail below. Various machine learning algorithms may be used without departing from the disclosure, such as supervised learning algorithms, unsupervised learning algorithms, abstract syntax tree algorithms, natural language processing algorithms, clustering algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, artificial neural network algorithms, and the like. Additional or alternative machine learning algorithms may be used without departing from the disclosure.

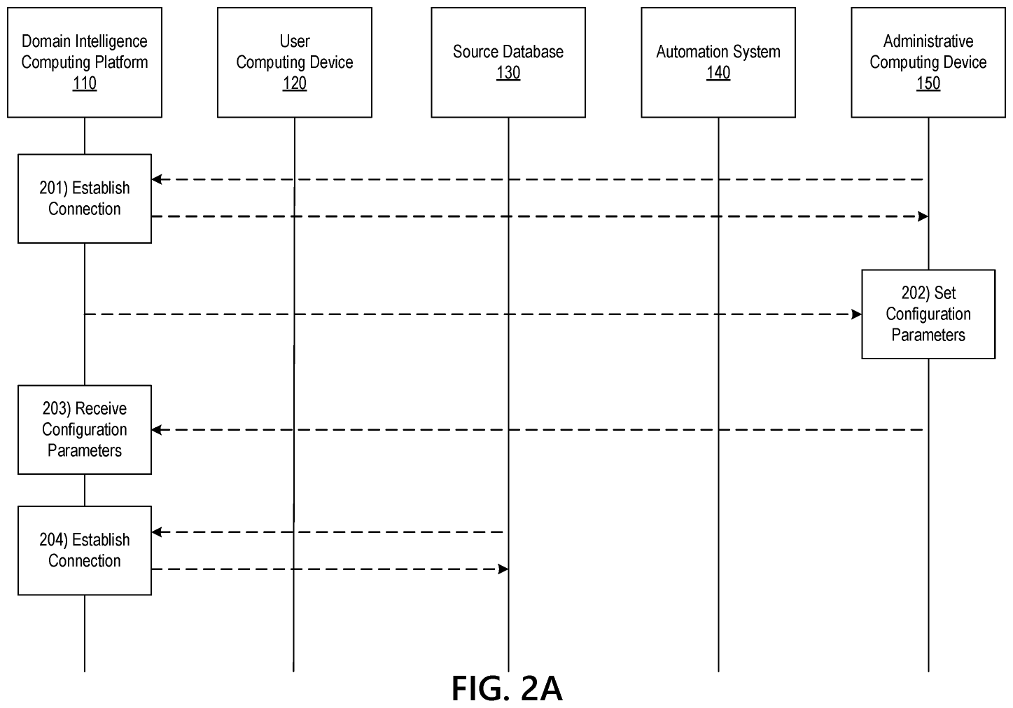

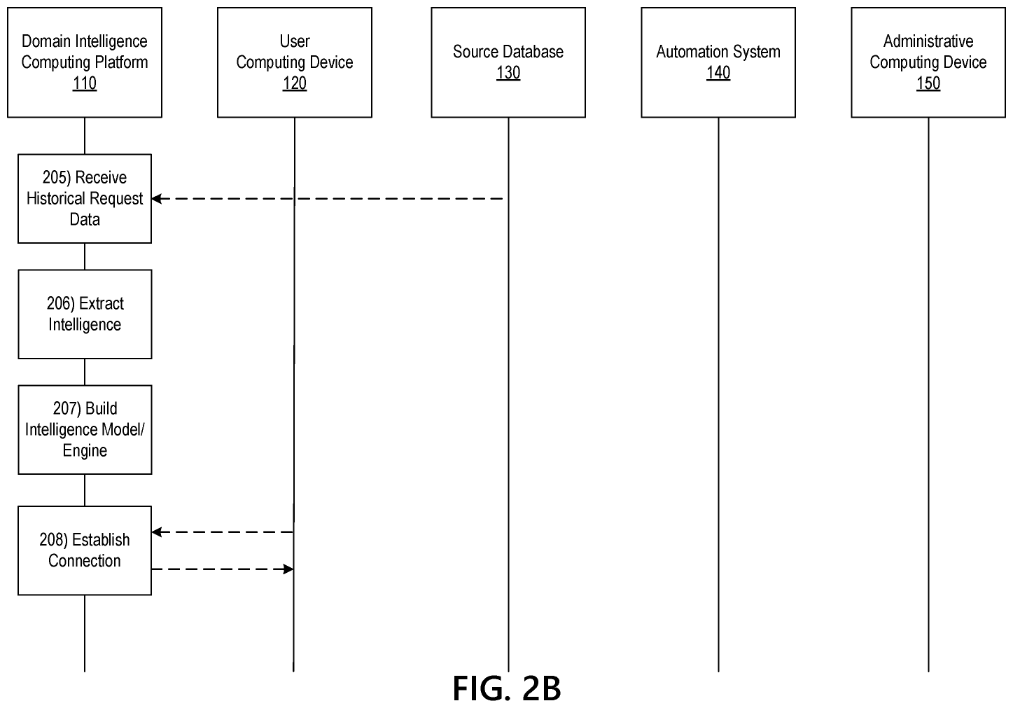

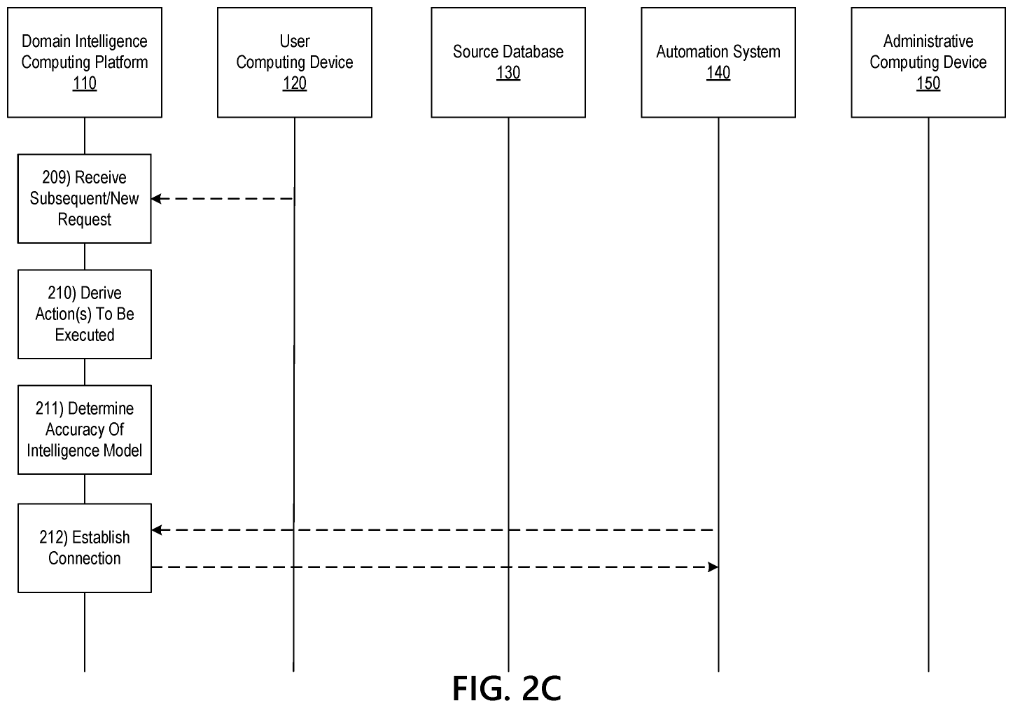

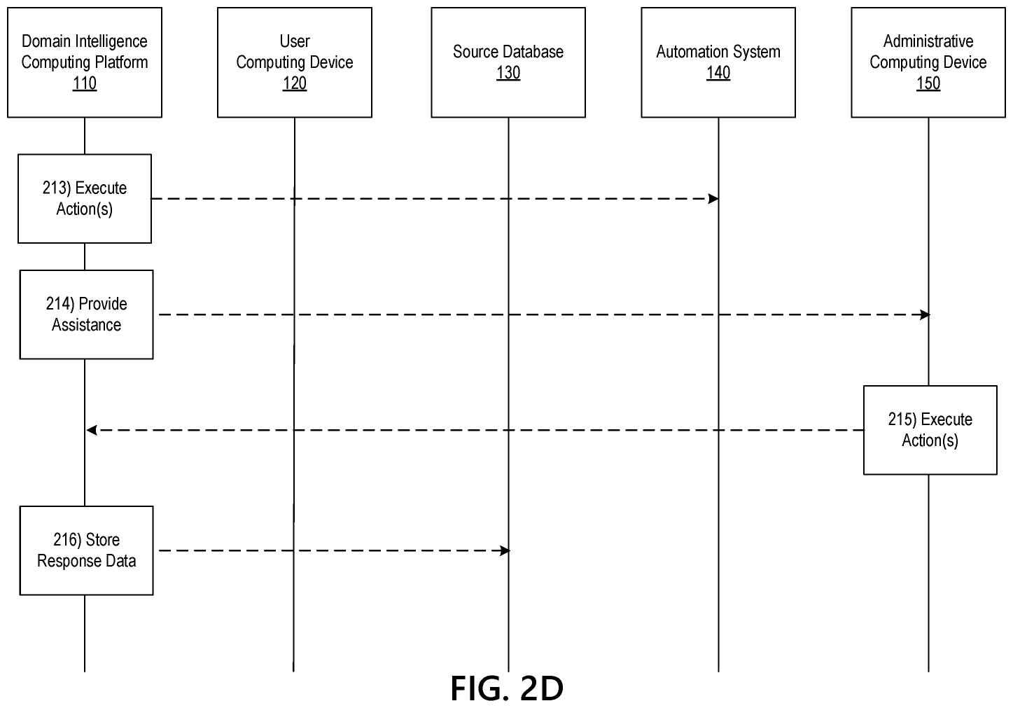

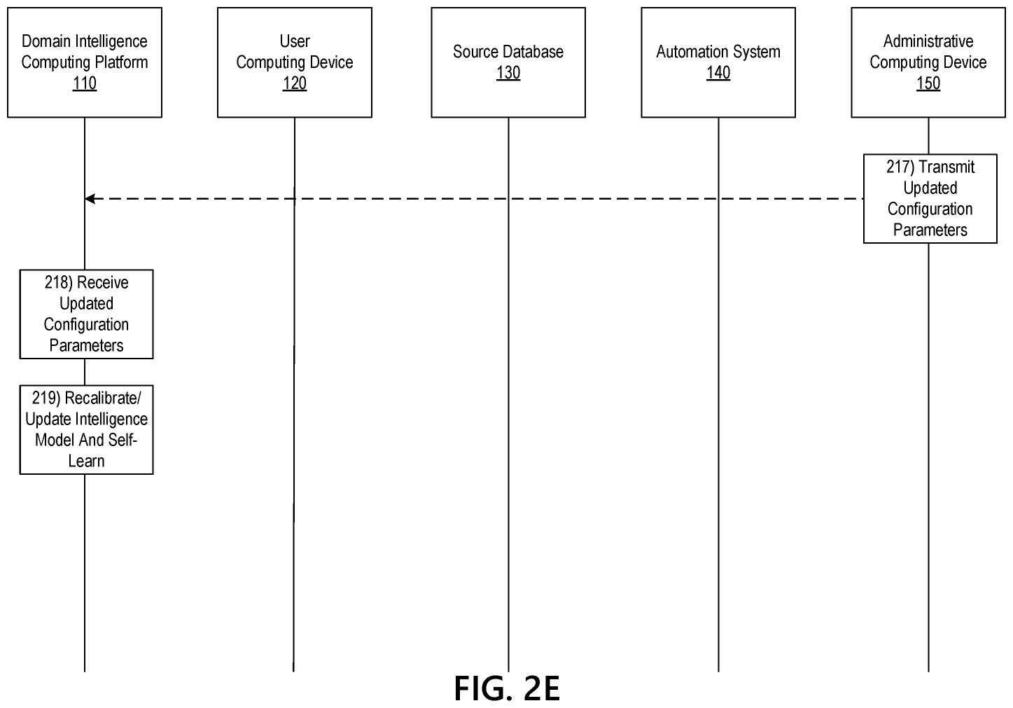

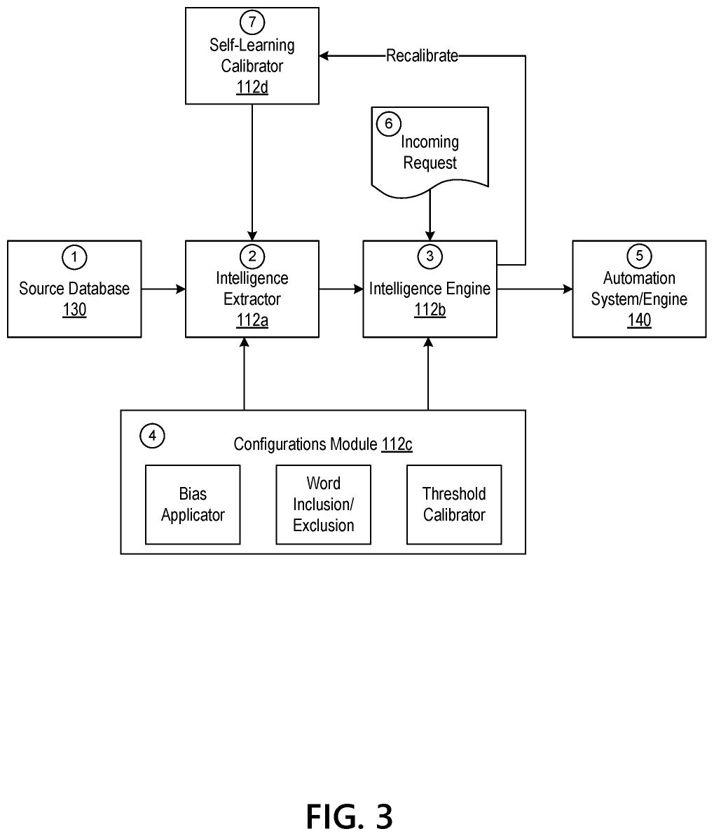

FIGS. 2A-2E depict one example illustrative event sequence for intelligently orchestrating and automating requests in accordance with one or more aspects described herein. The events shown in the illustrative event sequence are merely one example sequence and additional events may be added, or events may be omitted, without departing from the disclosure. Further, one or more processes discussed with respect to FIGS. 2A-2E may be performed in real-time or near real-time. FIG. 3 depicts an illustrative flow chart for intelligently orchestrating and automating requests in accordance with one or more arrangements discussed herein. For purposes of illustration, FIGS. 2A-2E and FIG. 3 will be discussed together.

With reference to FIG. 2A, at step 201, domain intelligence computing platform 110 may connect to administrative computing device 150. For instance, a first wireless connection may be established between domain intelligence computing platform 110 and administrative computing device 150. Upon establishing the first wireless connection, a communication session may be initiated between domain intelligence computing platform 110 and administrative computing device 150.

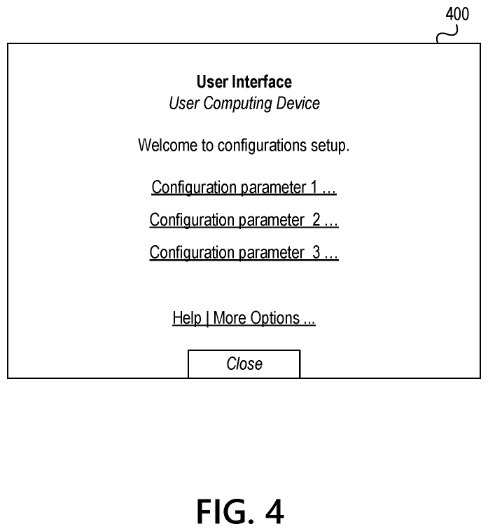

At step 202, a user of a computing device (e.g., administrative computing device 150) may set, and provide, via the communication interface (e.g., communication interface 113), configuration parameters to domain intelligence computing platform 110. In some examples, domain intelligence computing platform 110 may prompt a user of the computing device (e.g., administrative computing device 150) to set the configuration parameters. For instance, domain intelligence computing platform 110 may cause the computing device (e.g., administrative computing device 150) to display and/or otherwise present one or more graphical user interfaces similar to graphical user interface 400, which is illustrated in FIG. 4. As seen in FIG. 4, graphical user interface 400 may include text and/or other information associated with providing a notification regarding setting configuration parameters associated with the intelligent orchestration and automation of requests (e.g., “Welcome to configurations setup. [Configuration parameter 1 . . . ] [Configuration parameter 2 . . . ] [Configuration parameter 3 . . . ]”). It will be appreciated that other and/or different notifications may also be provided. In some examples, the configuration parameters may be and/or include weight/bias application information, word inclusion and exclusion criteria, a threshold calibration setting, and/or the like. In some examples the configuration parameters may include different configurations for different lines of business. For instance, each line of business may include or exclude different terms and might have different biases applied based on what is optimal for them. It will be appreciated that other and/or additional configurations may be implemented without departing from the scope of the present disclosure.

Returning to FIG. 2A, at step 203, domain intelligence computing platform 110 may receive, via the communication interface (e.g., communication interface 113), from the computing device (e.g., administrative computing device 150), the configuration parameters.

At step 204, domain intelligence computing platform 110 may connect to source database 130. For instance, a second wireless connection may be established between domain intelligence computing platform 110 and source database 130. Upon establishing the second wireless connection, a communication session may be initiated between domain intelligence computing platform 110 and source database 130.

With reference to FIG. 2B, at step 205, domain intelligence computing platform 110 (e.g., via intelligence extractor 112a, FIG. 3 at components 1 to 2) may receive, from a source data store (e.g., source database 130), historical response data indicating a plurality of previous responses to requests. For instance, domain intelligence computing platform 110 may take advantage of past actions taken by a technician to service requests and build a collection of those historical requests in source database 130.

At step 206, based on the configuration parameters and the historical response data, domain intelligence computing platform 110 (e.g., via intelligence extractor 112a, FIG. 3 at components 1 and 4, to 2) may extract, using a machine learning algorithm, intelligence information associated with the requests. For instance, the intelligence extractor 112a may use a machine learning algorithm that vectorizes text entered by an end user in the request and provides meaningful weights. The configuration parameters may enrich the extraction process such that the intelligence gathered targets the language used for a particular line of business. In some examples, extracting the intelligence information associated with the requests may include determining intent of the requests. At step 207, domain intelligence computing platform 110 may build an intelligence model using the extracted intelligence information (e.g., output from intelligence extractor 112a, FIG. 3 at components 2 to 3). For instance, domain intelligence computing platform 110 may train the intelligence model on historical response data, and as requests come in and are processed, the model may be updated continuously. As the model is being updated, domain intelligence computing platform 110 may, as described further below, monitor an accuracy of the intelligence model and initiate calibration when a decrease in accuracy of the model is detected.

At step 208, domain intelligence computing platform 110 may connect to user computing device 120. For instance, a third wireless connection may be established between domain intelligence computing platform 110 and user computing device 120. Upon establishing the third wireless connection, a communication session may be initiated between domain intelligence computing platform 110 and user computing device 120.

With reference to FIG. 2C, at step 209, domain intelligence computing platform 110 (e.g., via intelligence engine 112b) may receive, via the communication interface (e.g., communication interface 113), from the user computing device 120, a subsequent or new request (e.g., FIG. 3 at component 6 to 3). Requests may be initiated by various means such as by electronic mail, text message, web portal, or the like.

At step 210, domain intelligence computing platform 110 (e.g., via intelligence engine 112b) may automatically derive or infer, using the intelligence model, one or more actions in response to the subsequent request, which in turn may invoke various automations to complete the request (e.g., FIG. 3 at components 3 to 5).

As some background, conventionally, requests may be captured and translated into an IT service management system, and a record created, which is then manually reviewed and acted on by an analyst to provide the necessary service, which could include invoking an automation routine. In one non-limiting example, a rule might be captured as tiers leading to an end action (e.g., “Tier1”→“Tier2”→“Tier3”→“Action”). Each tier may include different options relating to various applications, hardware, software, or the like. To complete a service request through the legacy, manual process, a user would manually go through details of the request and drill down through the hierarchy of tiers/options (e.g., “Tier1”, “Tier2”, and “Tier3”) to finally arrive at, and select, the end action (“Action”). Advantageously, instead of going through the entire hierarchy, aspects of the disclosure may automatically/directly derive the end action. Additionally or alternatively, aspects of the disclosure may derive the tiers as desired or required.

At step 211, domain intelligence computing platform 110 (e.g., via intelligence engine 112b) may monitor and determine an accuracy of the intelligence model based on the configuration parameters (e.g., in configuration module 112c).

At step 212, domain intelligence computing platform 110 may connect to automation system 140. For instance, a fourth wireless connection may be established between domain intelligence computing platform 110 and automation system 140. Upon establishing the fourth wireless connection, a communication session may be initiated between domain intelligence computing platform 110 and automation system 140.

With reference to FIG. 2D, at step 213, domain intelligence computing platform 110 may process or respond to the subsequent request by executing the one or more actions in response to the subsequent request. In some examples, domain intelligence computing platform 110 (e.g., via intelligence engine 112b) may use parameters from configurations module 112c to make decisions on which actions should be completely automated versus providing appropriate aid to a technician. For example, if a particular action meets a particular threshold of accuracy, an automation process may be executed. For instance, domain intelligence computing platform 110 may automatically perform actions (e.g., via automation system/engine 140) on behalf of a user (e.g., technician).

Additionally or alternatively, at step 214, if a particular action does not meet the particular threshold of accuracy, processing the subsequent request may include providing assistance to an administrative computing device (e.g., administrative computing device 150). For instance, domain intelligence computing platform 110 may send a predicted or recommended action to the administrative computing device (e.g., administrative computing device 150), and a user of the administrative computing device (e.g., technician) may decide on and execute the appropriate response/action at step 215.

At step 216, domain intelligence computing platform 110 may store, in the source data store (e.g., source database 130), the one or more actions executed in response to the subsequent request.

With reference to FIG. 2E, at step 217, the user of the computing device (e.g., administrative computing device 150) may set, and provide, via the communication interface (e.g., communication interface 113), updated configuration parameters to domain intelligence computing platform 110. In turn, at step 218, domain intelligence computing platform 110 may receive, via the communication interface (e.g., communication interface 113), from the computing device (e.g., administrative computing device 150), the updated configuration parameters.

In some embodiments, at step 219, domain intelligence computing platform 110 (e.g., via self-learning calibrator 112d. FIG. 3 at component 7) may execute (e.g., in a backend process) an adaptive self-learning algorithm or other fine-tuning mechanism based on the processed subsequent requests to improve the accuracy of the intelligence model. In some examples, domain intelligence computing platform 110 may continually evaluate the output from intelligence extractor 112a/intelligence engine 112b and determine the accuracy of the intelligence model. Responsive to the accuracy of the intelligence model deteriorating (e.g., being below a threshold, seeing a continuous or multiple indications of a decline in accuracy, or the like), domain intelligence computing platform 110 (e.g., via self-learning calibrator 112d, FIG. 3 at components 2, 3, and 7) may recalibrate/update the intelligence model and self-learn (e.g., based on incoming new data/requests). This continuous feedback loop provides increased accuracy over time.

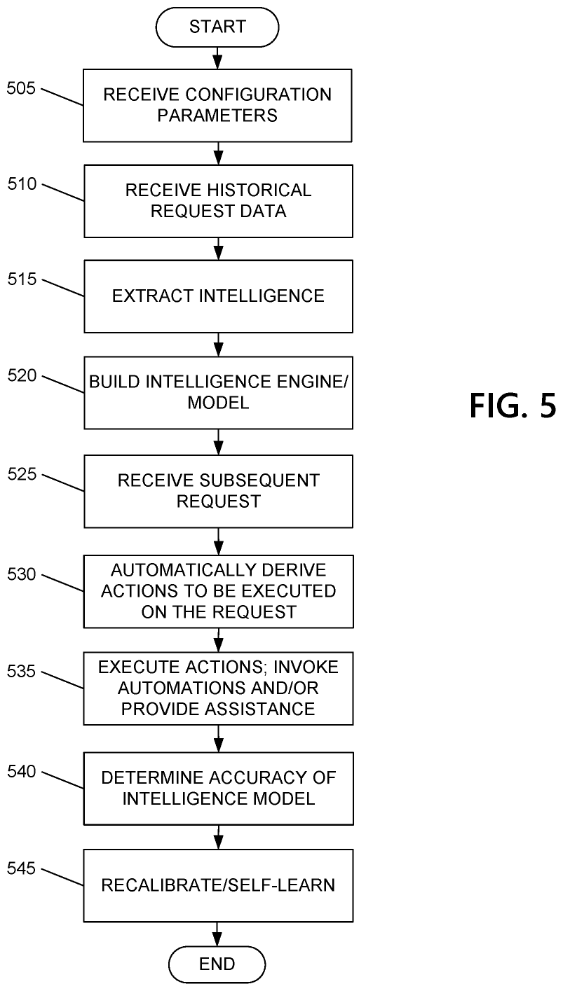

FIG. 5 depicts an illustrative method for intelligently orchestrating and automating requests in accordance with one or more example embodiments. With reference to FIG. 5, at step 505, a computing platform having at least one processor, a communication interface, and memory may receive configuration parameters from a computing device. At step 510, the computing platform may receive historical response data indicating a plurality of previous responses to requests from a source data store. At step 515, based on the configuration parameters and the historical response data, the computing platform may extract intelligence information associated with the requests using a machine learning algorithm. At step 520, the computing platform may build an intelligence model using the extracted intelligence information. At step 525, the computing platform may receive a subsequent request from the computing device. At step 530, the computing platform may automatically derive, using the intelligence model, one or more actions in response to the subsequent request. At step 535, the computing platform may process the subsequent request by executing the one or more actions in response to the subsequent request. At step 540, the computing platform may determine an accuracy of the intelligence model based on the configuration parameters. At step 545, responsive to the accuracy of the intelligence model being below a threshold, the computing platform may execute a self-learning algorithm based on the processed subsequent requests to improve the accuracy of the intelligence model.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive, via the communication interface, from a computing device, configuration parameters;
receive, from a source data store, historical response data indicating a plurality of previous responses to requests;
based on the configuration parameters and the historical response data, extract, using a machine learning algorithm, intelligence information associated with the requests;
build an intelligence model using the extracted intelligence information;
receive, via the communication interface, from the computing device, a subsequent request;
automatically derive, using the intelligence model, one or more actions in response to the subsequent request;
process the subsequent request by executing the one or more actions in response to the subsequent request;
determine an accuracy of the intelligence model based on the configuration parameters; and
responsive to the accuracy of the intelligence model being below a threshold, execute a self-learning algorithm based on the processed subsequent requests to improve the accuracy of the intelligence model.

2. The computing platform of claim 1, wherein extracting the intelligence information associated with the requests includes determining intent of the requests.

3. The computing platform of claim 1, wherein receiving the configuration parameters includes receiving bias application information, word inclusion and exclusion criteria, and a threshold calibration setting.

4. The computing platform of claim 1, wherein receiving the configuration parameters includes receiving different configurations for different lines of business.

5. The computing platform of claim 1, further including instructions that, when executed, cause the computing platform to:
store, in the source data store, the one or more actions executed in response to the subsequent request.

6. The computing platform of claim 1, wherein processing the subsequent request includes executing an automation process.

7. The computing platform of claim 1, wherein processing the subsequent request includes providing assistance to an administrative computing device.

8. The computing platform of claim 1, wherein extracting the intelligence information associated with the requests includes vectorizing words in the requests and assigning weights to the words.

9. The computing platform of claim 1, further including instructions that, when executed, cause the computing platform to:
prompt a user of the computing device to set the configuration parameters.

10. A method, comprising:
at a computing platform comprising at least one processor, a communication interface, and memory:
receiving, by the at least one processor, via the communication interface, from a computing device, configuration parameters;
receiving, by the at least one processor, from a source data store, historical response data indicating a plurality of previous responses to requests;
based on the configuration parameters and the historical response data, extracting, by the at least one processor, using a machine learning algorithm, intelligence information associated with the requests;
building, by the at least one processor, an intelligence model using the extracted intelligence information;
receiving, by the at least one processor, via the communication interface, from the computing device, a subsequent request;
automatically deriving, by the at least one processor, using the intelligence model, one or more actions in response to the subsequent request;
processing, by the at least one processor, the subsequent request by executing the one or more actions in response to the subsequent request;
determining, by the at least one processor, an accuracy of the intelligence model based on the configuration parameters; and
responsive to the accuracy of the intelligence model being below a threshold, executing, by the at least one processor, a self-learning algorithm based on the processed subsequent requests to improve the accuracy of the intelligence model.

11. The method of claim 10, wherein extracting the intelligence information associated with the requests includes determining intent of the requests.

12. The method of claim 10, wherein receiving the configuration parameters includes receiving bias application information, word inclusion and exclusion criteria, and a threshold calibration setting.

13. The method of claim 10, wherein receiving the configuration parameters includes receiving different configurations for different lines of business.

14. The method of claim 10, further comprising:
store, by the at least one processor, in the source data store, the one or more actions executed in response to the subsequent request.

15. The method of claim 10, wherein processing the subsequent request includes executing an automation process.

16. The method of claim 10, wherein processing the subsequent request includes providing assistance to an administrative computing device.

17. The method of claim 10, wherein extracting the intelligence information associated with the requests includes vectorizing words in the requests and assigning weights to the words.

18. The method of claim 10, further comprising:
prompting, by the at least one processor, a user of the computing device to set the configuration parameters.

19. One or more non-transitory computer-readable media storing instructions that, when executed by a computing platform comprising at least one processor, memory, and a communication interface, cause the computing platform to:
receive, via the communication interface, from a computing device, configuration parameters;
receive, from a source data store, historical response data indicating a plurality of previous responses to requests;
based on the configuration parameters and the historical response data, extract, using a machine learning algorithm, intelligence information associated with the requests;
build an intelligence model using the extracted intelligence information;
receive, via the communication interface, from the computing device, a subsequent request;
automatically derive, using the intelligence model, one or more actions in response to the subsequent request;
process the subsequent request by executing the one or more actions in response to the subsequent request;
determine an accuracy of the intelligence model based on the configuration parameters; and
responsive to the accuracy of the intelligence model being below a threshold, executing a self-learning algorithm based on the processed subsequent requests to improve the accuracy of the intelligence model.

20. The one or more non-transitory computer-readable media of claim 19, wherein receiving the configuration parameters includes receiving bias application information, word inclusion and exclusion criteria, and a threshold calibration setting.
